(19) United States
(12) Patent Application Publication
(10) Pub. No.: US 2008/0178233 A1
(43) Pub. Date: Jul. 24, 2008

(54) Audio and video program purchasing

(76) Inventor: Richard J. Goc, Folsom, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/656,061

(22) Filed: Jan. 22, 2007

(51) Int. Cl. H04N 7/173

(52) U.S. Cl. 725/91

(57) ABSTRACT

Methods, computer readable media, and system embodiments are provided for purchasing audio and video programs. A method embodiment includes receiving program content transmitted from a content provider network to a subscriber station, the subscriber station including an output device. The method includes outputting the transmitted program content via the output device, the program content being output corresponding to a portion of a particular program, wherein the portion of the particular program is selected from the group including a portion of an audio program and a portion of a video program. The method includes, while the program content is being output, purchasing the particular program by providing a user input to a subscriber device of the subscriber station.

### BACKGROUND

Audio and/or video information, e.g., music and/or movies, can be obtained from content providers such as cable/satellite television providers and satellite radio providers, among others. In some cases, the received audio and/or video can be stored for future playback. As an example, a cable/satellite television subscriber may have a DVR (digital video recorder) that can be used to record television shows and/or movies for future viewing. However, a subscriber may not be able to transfer the stored programs to physical storage media, e.g., CDs (compact discs), DVDs (digital video discs), cassette tapes, computer hard drives, and/or portable devices such as mp3 players and PDAs (personal digital assistants), to name a few. In some cases, such transfer, e.g., copying, of the audio/video is illegal.

In order to obtain personal copies of particular programs such as songs, television shows, and movies available from a content provider, a person can physically go to a store and purchase the programs. The person can also purchase the particular programs by ordering them online via a website. In such cases, the programs can be delivered via a postal service or they can be delivered to the person electronically, e.g., downloaded to a computing device.

Purchasing audio and/or video programs in the manners described above can be time consuming and may not be possible in some instances. For example, in various situations, a person viewing and/or listening to program selections received from a content provider may be unaware of or forget information used to identify the program, e.g., song title, movie title, artist, etc. In such instances, the lack of information may prevent the person from purchasing the program. For instance, the person may be unable to obtain the program without the information and/or may be unwilling to spend time searching for the information.

Even if a person knows the information used to purchase the program selection, the person may be unwilling and/or unable to spend time physically traveling to a store or visiting an internet website to purchase the program.

### BRIEF DESCRIPTION OF THE DRAWINGS

FIG. 1 is a block diagram illustrating system for purchasing audio and video programs according to an embodiment of the present disclosure.

FIG. 2 is a block diagram illustrating an embodiment of a method of purchasing audio and video programs according to an embodiment of the present disclosure.

### DETAILED DESCRIPTION

Embodiments of the present disclosure include methods, computer readable media, and systems for purchasing audio and video programs. A method embodiment includes receiving program content transmitted from a content provider network to a subscriber station, the subscriber station including an output device. The method includes outputting the transmitted program content via the output device, the program content being output corresponding to a portion of a particular program. The portion of the particular program is an audio and/or a video program. The method includes, while the program content is being output, purchasing the particular program by providing a user input to a subscriber device of the subscriber station.

Embodiments of the present disclosure and features thereof can be performed by software, firmware, hardware, application modules, and the like. These embodiments can use instructions resident on and/or executable by circuits such as Application Specific Integrated Circuits (ASICs), devices, systems, or networks shown herein or otherwise.

The embodiments of the present disclosure are not limited to any particular operating environment or to instructions written in any particular programming language. Software, firmware, and/or processing modules, suitable for carrying out embodiments of the present disclosure, can be resident on one or more devices in one or more locations.

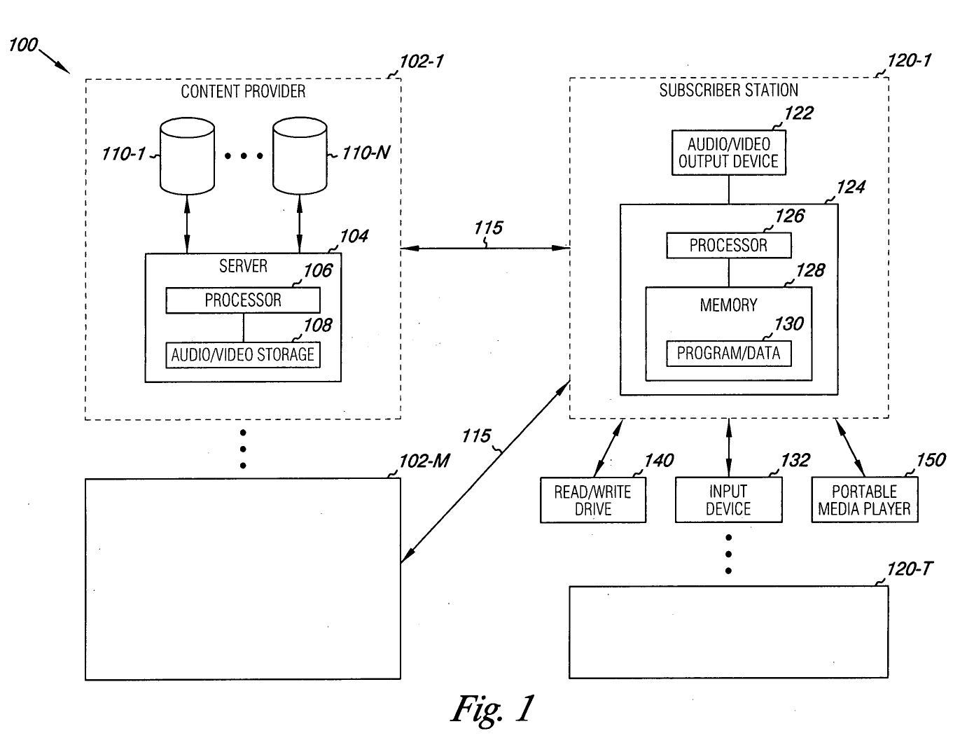

FIG. 1 is a block diagram illustrating a system 100 for purchasing audio and video programs according to an embodiment of the present disclosure. In the embodiment illustrated in FIG. 1, the system 100 includes a number of content provider networks 102-1, . . . , 102-M in communication with a number of subscriber stations 120-1, . . . , 120-T via connections 115. The designators “M” and “T” are used to indicate that the system 100 can include a number of content provider networks and/or a number of subscriber stations. The connections 115 can be telephone connections, satellite connections, coaxial cable connections, or a combination thereof, among other connections which may depend on various factors such as the type of content provider and/or type of subscriber station. The content provider networks 102-1-102-M and/or the subscriber stations 102-1-102-T can be connected to a communications network such as the PSTN (public switched telephone network) and/or the Internet, for example.

Examples of content provider networks 102-1-102-M include, but are not limited to satellite television provider networks, satellite radio provider networks, and/or cable television provider networks, among other provider networks capable of transmitting audio and/or video programs, e.g., songs, books, television shows, movies, etc., to subscribers of the network services. In various embodiments, a content provider network includes a provider computing device, e.g., a server 104, that includes a storage medium, e.g., storage medium 108, on which a number of audio and/or video programs and/or identification data related thereto can be stored. In various embodiments, the identification data can include a song title, movie title, artist name, and/or a cost associated with purchasing the particular program and can be transmitted along with the program content. The storage medium 108 can be, for example, memory in the form of a number of hard disks among various other storage media. The audio and/or video programs, e.g., music and/or movie files, can be digitally stored in a compressed format, e.g., an MPEG format, or uncompressed format.

In various embodiments, the audio and/or video programs and/or data related thereto can be transmitted from the server 104, or another content provider device, to a subscriber station, e.g., 120-1-120-T. For example, executable instructions can be executed by a processor, e.g., processor 106, to transmit audio and/or video programs and/or identification data related thereto a subscriber station 120-1-120-T via connection 115.

In various embodiments, the audio and/or video programs transmitted from a content provider network 102-1-102-M, can be purchased by a subscriber. That is, copies of program content, e.g., songs, books, television shows, and/or movies, can be legally obtained, e.g., downloaded to a subscriber device, e.g., subscriber device 124, for future playback on a subscriber station or transfer to another device and/or storage medium such as a portable media player and/or a CD, for example. As one of ordinary skill in the art will appreciate, in some situations, it can be illegal to download, e.g., record, programs to a subscriber device and/or to make additional copies of the programs by transferring them to another device or storage medium without purchasing the program.

As illustrated in the embodiment of FIG. 1, the content provider network can include one or more subscriber management servers 110-1, . . . 110-N, e.g., databases. The designator “N” is used to indicate that the content provider network can include a number of subscriber management servers. In various embodiments, the subscriber management servers 110-1-110-N can include account data and information, e.g., service plans and/or account balances, among other information, associated with subscriber stations 120-1-120-T. The subscriber management servers 110-1-110-N can include memory and processing resources to process program purchase signals transmitted to a provider network 102-1-102-M from a subscriber station 120-1-120-T. The program purchase signals can include program identification data indicating a particular audio and/or video program a subscriber, e.g., a user of subscriber device 124, desires to purchase. In various embodiments, the subscriber management servers 110-1-110-N can perform billing functions of the provider network 102-1-102-M, e.g., updating subscriber account information based on audio and/or video program purchases, for example.

In various embodiments of the present disclosure, the subscriber stations 102-1-102-T can include an output device 122 for playing transmitted program content, e.g., audio and/or video programs such as songs and/or movies, received to the subscriber station 120-1 from a provider network 102-1-102-M. As used herein, playing program content can refer to both playing audio output and displaying video output.

The output device 122 can be a television, a stereo, a laptop or desktop computer, a PDA (personal digital assistant), or a cellular telephone, among other devices capable of outputting, e.g., playing, program content transmitted from a content provider network 102-1-102-M. As one of ordinary skill in the art will appreciate, the subscriber stations 102-1-102-T can include various other components such as a receiver and/or a modem that can be coupled to output device 122. It is noted that discussions and descriptions of subscriber station 120-1 are applicable for each subscriber station 102-1-102-T.

In various embodiments, and as illustrated in FIG. 1, the subscriber station 120-1 can include a subscriber device 124 coupled to the output device 122. The subscriber device 124 includes a processor 126 and a memory 128. The memory 128 includes executable instructions, e.g., program/data 130, stored thereon. In various embodiments, and as described further below, executable instructions corresponding to program/data 130 can be executed by a processor, e.g., processor 126, to allow a user of subscriber station 120-1 to purchase a particular program, while program content corresponding to the particular program is being output by the output device 122, based on a user input.

In various embodiments of the present disclosure, a purchased particular program can be downloaded to a subscriber station from the provider network. Purchasing a particular program and downloading the purchased particular program from a content provider network 102-1-102-M, can prevent a subscriber from having to purchase a desired particular program by visiting a separate network, e.g., via an internet website, and/or by physically traveling to a store to obtain a legal copy of the program.

In some embodiments, the subscriber device 124 can be a set top box that can be purchased by a subscriber or provided to the subscriber by the content provider. For example, if the content provider 102-1 is a digital cable provider, then the subscriber device 124 can be a digital cable set-top box (DSTB) that provides the functions of receiving cable signals by tuning to the appropriate RF channel, processing the received signal and outputting audio/video signals for listening/viewing on a display unit, e.g., output device 122.

As shown in FIG. 1, in various embodiments, the subscriber station 120-1 can be coupled to an input device 132. The input device 132 can include a remote control device capable of wireless communication with the subscriber station 120-1 and/or devices thereof, e.g., output device 122 and/or subscriber device 124. Embodiments are not limited to a particular input device, e.g., input device 132 may be a wired input device and/or may be physically located on a device of subscriber station 120-1, e.g., devices 122 and/or 124.

In various embodiments, audio and/or video programs stored on the memory 128 of subscriber device 124 can be transferred to another storage medium or device. That is, purchased particular programs and/or copies thereof can be transferred from a subscriber device, e.g., 124, to other media and/or devices. Examples of such storage media and/or devices can include electronic, magnetic, and/or optical media devices such as hard drives, flash memory devices, CD ROMs, DVDs, tapes, cellular telephones, PDAs, and portable media players, among other storage media and/or device types. Embodiments, however, are not limited to these examples. In some embodiments, a purchased particular program can be downloaded directly to a device such as a portable media player coupled to the subscriber station and/or can be transferred thereto from a subscriber device, e.g., 124.

As an example, in the embodiment illustrated in FIG. 1, the subscriber station 120-1 is coupled to a read/write drive 140 and a portable media player 150. In some embodiments, a purchased particular program can be downloaded from a provider network 102-1-102-M to the portable media player 150, e.g., a digital audio player such as an MP3 player or other portable media device capable of providing audio and/or video output. Also, in some embodiments, instructions can be executed to transfer one or more purchased particular programs or copies thereof to a storage medium such as a CD or DVD via read/write drive 140.

In various embodiments, the subscriber station 120-1 is located in a subscriber's home, e.g., the subscriber station 120-1 can be a home entertainment center. In such embodiments, the subscriber stations 120-1 can receive digital and/or analog transmissions from a number of content providers 102-1-102-M. In embodiments in which the subscriber station 120-1 is a home subscriber station, the subscriber device 124, e.g., a set top box, can be referred to as a home subscriber device.

As described herein, in various embodiments, the subscriber device 124 can be a recording device, e.g., a digital video recorder (DVR) or other device capable of storing audio and/or video programs on a memory thereof. In various embodiments, instructions, e.g., program/data 130, stored on the memory 128, can be executed by processor 126 to download programs and/or identification data related thereto from a content provider network 102-1-102-M and store them on memory 128 of the subscriber device 124. As mentioned above, in some embodiments, instructions can be executed to download programs to devices, other than subscriber device 124, coupled to the subscriber station 120-1, e.g., portable media player 150.

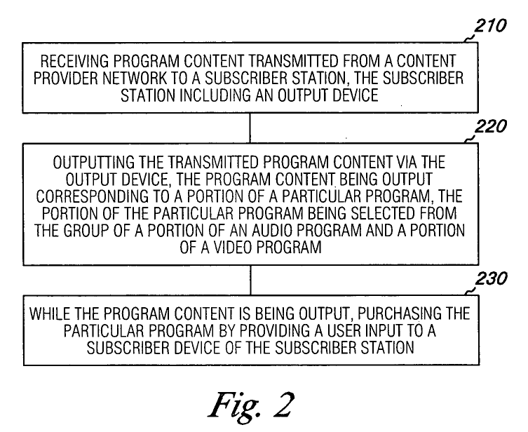

FIG. 2 is a block diagram illustrating an embodiment of a method of purchasing audio and video programs according to an embodiment of the present disclosure. At block 210, the method includes receiving program content transmitted from a content provider network to a subscriber station, the subscriber station including an output device. As described above in connection with FIG. 1, the program content can include audio and/or video programs, e.g., songs, television shows, movies, and/or books. The program content can be transmitted from various types of provider networks such as cable television networks, satellite television networks, and/or satellite radio networks, among other types of provider networks. The output device can be various devices capable of playing transmitted program content, e.g., televisions, stereos, PDAs, cellular telephones, radios, etc. In various embodiments, the subscriber station can be a home subscriber station such as a digital home entertainment center.

At block 220, the method illustrated in FIG. 2 includes outputting the transmitted program content via the output device. In various embodiments, the program content being output corresponds to a portion of a particular program, e.g., a portion of an audio program and/or a portion of a video program. For example, a subscriber or user of the subscriber station can listen to a song being played and/or can listen to and/or view a movie being played by the output device.

As shown at block 230, the method illustrated in FIG. 2 includes, while the program content is being output, e.g., played and/or displayed, purchasing the particular program by providing a user input to a subscriber device of the subscriber station. The user input can be provided via an input device such as input device 132 shown in FIG. 1, e.g., a wireless remote control device or other suitable input device.

As an example, a user of the subscriber station may be listening to a song being transmitted from a content provider network and output by the output device. In such cases, the user may desire to purchase the particular song being played, e.g., in order to obtain a personal copy of the particular song being played in a legal manner. In this example, the user can provide an input signal to the subscriber device via the input device, e.g., by pressing a “purchase” button on a remote control, while the song is playing. In various embodiments, at least some identification data related to the transmitted program content can be provided to a user while the program content is playing. For example, in some embodiments, instructions can be executed to provide the user with a cost associated with purchasing the particular program while the program content is playing.

In various embodiments, the user input initiates transmission of a program purchase signal. That is, instructions stored on a memory of the subscriber device can be executed by a processor thereof to transmit a program purchase signal to the content provider network, e.g., to a subscriber management server such as server 110-1-110-N shown in FIG. 1. The program purchase signal can include identification data corresponding to the particular program. Instructions can be executed by the subscriber management server to process the program purchase signal. Processing the program purchase signal can include identifying the particular song being purchased by the user and updating the appropriate subscriber account.

In various embodiments of the present disclosure, instructions can be executed to download a purchased particular program from the content provider network to the subscriber station. That is, a particular purchased program stored on a provider network device can be downloaded from the provider network device to a subscriber device. For example, in the embodiment illustrated in FIG. 1, a particular purchased program stored on memory 108 of server 104 can be downloaded to memory 128 of subscriber device 124. In this manner, in various embodiments, a particular program can be transmitted, purchased, and downloaded from a single content provider network.

In such embodiments, instructions can be executed to download at least some of the purchased particular program from the content provider network, e.g., from server 104 of provider network 102-1 shown in FIG. 1, while the program content is being output via the output device. For instance, the user can obtain an authorized, e.g., legal, copy of a particular audio or video program while simultaneously listening to and/or viewing the particular program.

In some cases, a user may desire to flag, e.g., for possible future purchase, a particular audio or video program being transmitted from a content provider and being output by an output device of a subscriber station. As such, in some embodiments of the present disclosure, instructions can be executed to store identification data relating to the particular program on a subscriber device of the subscriber station, e.g., device 124 shown in FIG. 1, in response to a first user input to the subscriber device, while the program content is playing and/or being displayed. The identification data can include a song title, movie title, artist name, and/or a cost associated with purchasing the particular program and can be transmitted to the subscriber station along with the program content. The first user input can be provided via an input device such as input device 132 shown in FIG. 1, e.g., a wireless remote control device or other suitable input device.

In such embodiments, the user can provide the first user input in the form of a first input signal to the subscriber device via the input device, e.g., by pressing a “save” button on a remote control, while the song is playing. The stored identification data includes information such as a song title, artist name, movie title, and/or other information that a user can use to identify the particular program. In some embodiments, the stored identification data can include a cost associated with purchasing the particular program. In such embodiments, instructions can be executed to add “saved” programs to a list that includes the stored identification data relating to particular programs that a user has “saved.” In embodiments in which identification data is stored based on a first user input to the subscriber device, a user can purchase the particular program via a second user input to the subscriber device. As an example, the second user input can include using the input device to select the particular program desired to be purchased from a list, e.g., a list of “saved” programs that can be stored on a memory of the subscriber device. The list of “saved” programs can include the stored identification data relating to the particular program the user desires to purchase. As the reader will appreciate, selecting the particular program desired to be purchased from the list can be accomplished in various manners. For instance, the user can provide a second input signal to the subscriber device via the input device, e.g., by pressing a “purchase” button on a remote control. As an example, the input device may be used to scroll through the list of “saved” programs, e.g., a list of stored identification data entries presented to a user, and the “purchase” button can be pressed to purchase a highlighted entry. Embodiments of the present disclosure are not limited to a particular manner of providing the first and/or second user input.

In embodiments in which identification data is stored based on a first user input to the subscriber device, the second user input, e.g., the user input used to purchase a particular program may or may not be provided while the program content is playing. That is, a user can elect to purchase the particular program while it is being transmitted to the subscriber station and/or being output by an output device. A user may also elect to purchase the particular program when the particular program is not being transmitted and/or output, e.g., after the program has finished.

In various embodiments, instructions can be executed to download a purchased particular purchased program to a portable media player coupled to the subscriber station, e.g., portable media player 150 shown in FIG. 1, in response to the second user input, e.g., a user input that generates transmission of a program purchase signal to the content provider network. In such embodiments, the purchased particular program can be downloaded directly to the portable media player from the provider network, e.g., from provider server such as server 104 shown in FIG. 1.

In various embodiments, program content may be stored on a subscriber device, e.g., device 124 shown in FIG. 1, prior to the first and/or the second user input. For example, in embodiments in which the subscriber device is a recording device such as a DVR device, the DVR may have a number of audio and/or video programs stored thereon, e.g., programs that have been transmitted from a provider network and recorded on the DVR for future playback, e.g., future listening/viewing via an audio/video output device. In such embodiments, a user of the DVR can purchase a particular program while it is being played back in various manners as described herein.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for purchasing audio and video programs, comprising:
receiving program content transmitted from a content provider network to a subscriber station, the subscriber station including an output device;
outputting the transmitted program content via the output device, the program content being output corresponding to a portion of a particular program, the portion of the particular program being selected from the group of:
a portion of an audio program; and
a portion of a video program;
while the program content is being output, purchasing the particular program by providing a user input to a subscriber device of the subscriber station.

2. The method of claim 1, wherein the method includes:
downloading the purchased particular program from a content provider device of the content provider network; and
storing the downloaded program on a memory of the subscriber device.

3. The method of claim 2, wherein downloading at least some of the purchased particular program from the content provider device of the content provider network occurs while the program content is being output via the output device.

4. The method of claim 2, wherein the method includes transferring the stored downloaded program to a portable media player coupled to the subscriber device.

5. The method of claim 1, wherein providing the user input initiates transmission of a program purchase signal to a subscriber management server of the content provider network, the program purchase signal indicating the purchased particular program.

6. The method of claim 5, wherein the method includes updating account data stored on the subscriber management server corresponding to an account associated with the subscriber station, based on the program purchase signal.

7. The method of claim 1, wherein the method includes transmitting the program content from a cable television provider network.

8. The method of claim 1, wherein the method includes transmitting the program content from a satellite television provider network.

9. A computer readable medium having executable instructions stored thereon that can be executed by a computing device to perform a method, comprising:
receiving transmitted program content and identification data related thereto from a content provider network to a home subscriber station;
playing the received program content on an output device, the playing program content corresponding to a particular program, the particular program being selected from the group of:
an audio program; and
a video program;
while the program content is playing, storing identification data relating to the particular program on a home subscriber device of the subscriber station in response to a first user input; and
purchasing the particular program by providing a second user input to the home subscriber device.

10. The medium of claim 9, wherein purchasing the particular program includes purchasing the particular program by providing the second user input while the program content is playing.

11. The medium of claim 9, wherein the method includes downloading the particular program to the home subscriber device in response to the second user input.

12. The medium of claim 9, wherein providing the second user input includes selecting the particular program from a list that includes the stored identification data relating to the particular program the user desires to purchase.

13. The medium of claim 9, wherein the method includes storing the particular program on a memory of the home subscriber device prior to the first user input and the second user input.

14. The medium of claim 9, wherein the method includes downloading the particular program to a portable media player coupled to the subscriber station in response to the second user input.

15. The medium of claim 9, wherein the method includes providing the user with a cost associated with purchasing the particular program

16. The medium of claim 15, wherein the method includes providing the user with the cost associated with purchasing the particular program while the program content is playing.

17. A system for purchasing audio and video programs, comprising:
a content provider network for transmitting audio and video program content to a subscriber station, wherein the content provider network includes:
a provider device including a number of content programs stored on a memory thereof; and
a subscriber management database including account information associated with a number of subscribers;
an output device for outputting program content transmitted to the subscriber station from the content provider network; and
a recording device coupled to the output device, the recording device having a processor and a memory coupled to the processor, wherein the memory includes instructions stored thereon that can be executed by the processor to perform a method that includes allowing a user to purchase a particular program by providing an input to the subscriber station while a portion of the particular program is being output by the output device.

18. The system of claim 17, wherein the memory includes instructions stored thereon that can be executed by the processor to download the purchased particular program to a portable media player coupled to the subscriber station.

19. The system of claim 18, wherein the portable media player is a digital audio player coupled to the subscriber station.

20. The system of claim 17, wherein the memory includes instructions stored thereon that can be executed by the processor to download the purchased particular program to the recording device of the subscriber station, and wherein the subscriber station is a home digital entertainment center.
